(19) United States
(12) Patent Application Publication
(10) Pub. No.: US 2013/0298019 A1
(43) Pub. Date: Nov. 7, 2013

(54) User Interface (UI) Mechanism for Changing Difficulty Levels within an Exercise Application Delivered Via the Internet

(71) Applicant: PRIMEWELLNESS LLC, Boulder, CO (US)

(72) Inventor: Matthew Henderson, Boulder, CO (US)

(73) Assignee: PrimeWellness LLC, Boulder, CO (US)

(21) Appl. No.: 13/874,611

(22) Filed: May 1, 2013

Related U.S. Application Data
(60) Provisional application No. 61/641,412, filed on May 2, 2012.

(51) Int. Cl. G06F 3/0484

(52) U.S. Cl. CPC G06F 3/0484
USPC 715/708

(57) ABSTRACT

Systems and methods for enabling an end-user of an online exercise application to change exercise difficulty levels by interacting with a control panel on the application graphical user interface. The end-user may cause the application to retrieve an easier or harder exercise video in order to achieve an adaptable, personalized level of difficulty. For example, if an end user begins watching an exercise of a given difficulty level within a module, the use may input a command to transition to a more (or less) difficult exercise within that module. The application will retrieve a new exercise and present the newly retrieved exercise to the end user. A “storyboard” depicting each of the exercises in the program may be depicted in a small row of tiles below a video player.

### CROSS-REFERENCE TO RELATED APPLICATION

The present application claims priority to U.S. Provisional Patent Application No. 61/641,412, filed May 2, 2012, entitled “USER INTERFACE (UI) MECHANISM FOR CHANGING DIFFICULTY LEVELS WITHIN AN EXERCISE APPLICATION DELIVERED VIA THE INTERNET,” the disclosure of which is incorporated herein by reference in its entirety.

### BACKGROUND

Web-based health and wellness applications in a variety of fields such as occupational therapy, sports & fitness, rehabilitation therapy, and others facilitate on-demand access to health and wellness exercise information. Such routines provide a narrative of exercises, often as videos, that are played by end users in, e.g., a web browser or media player. Some web-based programs are tailored for a particular fitness level of the end user. However, if the web-based program is not at an appropriate level for the end user, the benefits of such programs is reduced or an end user may overexert him/herself, leading to an injury.

### SUMMARY

Disclosed herein are systems and methods for enabling an end-user of an online exercise application to change exercise difficulty levels by interacting with a control panel on the application graphical user interface. The end-user may cause the application to retrieve an easier or harder exercise video in order to achieve an adaptable, personalized level of difficulty.

In accordance with some aspects, there is provided a method for customizing an exercise program having a plurality of modules, each of the plurality of modules having a plurality of levels of difficulty. The method may include communicating a web page from a website associated with exercise application to an end user at a computing device; presenting the exercise program in a graphical user interface that includes a control panel having level of difficulty controls that change a level of difficulty of one of the plurality of modules currently being displayed in the graphical user interface; receiving, via the control panel in the graphical user interface, end user commands; altering a level of difficultly of the one of the plurality of modules currently being displayed in the graphical user interface by retrieving another of the plurality of levels of difficulty of the one of the plurality of modules currently being displayed; and storing, on a per-end user basis, the altered level of difficulty of the one of the plurality of modules currently being displayed in a database.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is simplified block diagrams illustrating an example environment;

FIG. 2 illustrates an exercise program of FIG. 1 having modules at various levels of difficulty;

FIG. 3 illustrates an operational flow diagram of an example process in accordance with the present disclosure

FIGS. 4A, 4B and 4C illustrate a control panel in accordance with the present invention;

FIGS. 5A and 5B illustrate exemplary user interfaces; and

FIG. 6 illustrates an exemplary computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for remotely accessing applications, it will become evident to those skilled in the art that the implementations are not limited thereto, but are applicable for remotely accessing any type of data or service via a remote device.

### Overview

In accordance with the present disclosure, there is provided a system and method for enabling an end-user of an online exercise application to change exercise difficulty levels by interacting with a control panel on the application graphical user interface. The end-user may cause the application to retrieve an easier or harder exercise video in order to achieve an adaptable, personalized level of difficulty.

For example, if an end user begins watching an exercise of a given difficulty level within a module, the use may input a command to transition to a more (or less) difficult exercise within that module. The application will retrieve a new exercise and present the newly retrieved exercise to the end user from, e.g., the beginning. For example, in accordance with some implementations, if the end user progresses 30 seconds into a video and inputs the command to change the level of difficulty, the newly retrieved video will begin at time 0:00. Hence, the total workout time may be extended when the end user inputs a command to change the level of difficulty. The degree to which the session is extended depends on the number of times the end user changes the level of difficulty.

Optionally or additionally, a “storyboard” depicting each of the exercises in the program is depicted in a small row of tiles below a video player. When the level of difficulty within a module is changed, the relevant tile within the overall storyboard will change to denote the change to a different exercise. This mechanism provides the end user with additional visual feedback

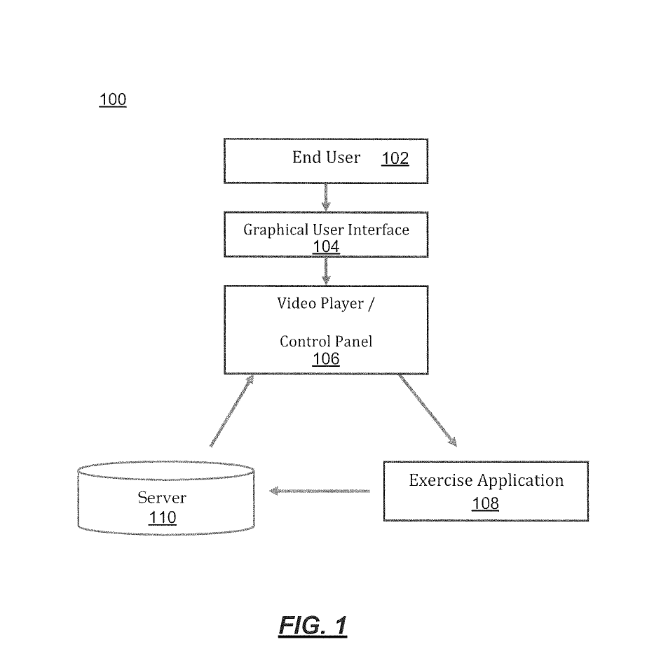

Referring to FIG. 1, there is illustrated an example environment 100 in which aspects of the present disclosure may be implemented. An end user 102 may interact with a graphical user interface 104 by inputting a programming command. The input may be received in a variety of ways depending on the computing device the end-user 102 is using to interact with the program. For example, if the case of a tablet computer, the user may tap a button on the screen with their finger, or stylus, causing the command to be relayed to produce the exercise of a different difficulty level. For a laptop computer, the end-user may utilize a mouse to input the same command.

A video player/control panel 106 is displayed on, e.g., a webpage provided by website associated with an exercise application provider, such as PrimeWellness.com. The video player/control panel 106 may be rendered using Hypertext Markup Language (HTML5). HTML5 adheres to established Internet standards, enabling the web application to maintain a consistent experience across a wide variety of computing devices and Internet browsers.

The video player/control panel 106 provides instructions to an exercise application 108. The exercise application 108 supplies the end user 102 with a series of short exercise lessons on how to correctly perform physical therapy exercises relevant to their wellness. When the end user adheres to a particular exercise program 108 over, e.g., several weeks, or just days, their capabilities often improve. The graphical user interface 104 allows the user to retrieve a harder exercise allows the end user 102 to self-manage their improvement instead of growing bored and quitting the program 108 because it is too easy. Conversely, sometimes an end user 102 may suffer a setback in his/her abilities (e.g. the end user suffers a fall) and he/she may need to make the exercises easier to account for this reduction in physical ability. The graphical user interface 104 enables both of these actions.

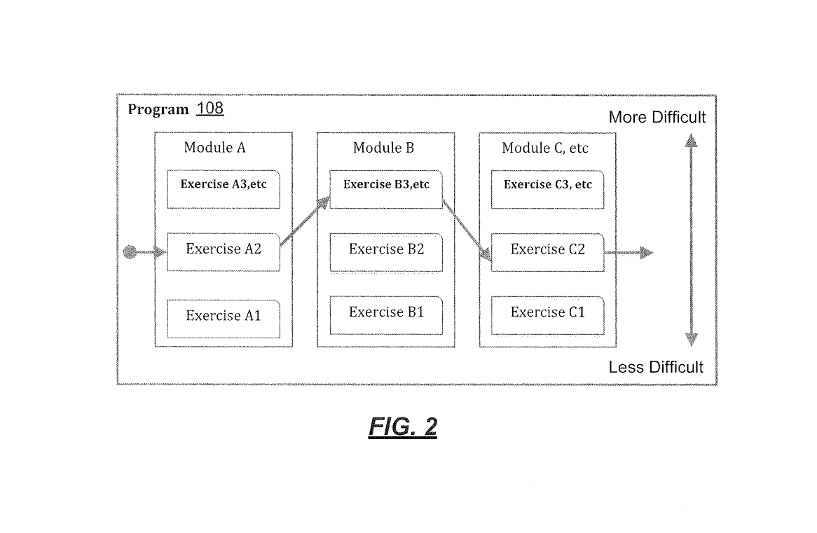

An example exercise application 108 is shown in FIG. 2. The exercise program 108 contains one or more modules (Module A, Module B, Module C and so on) that each may be distinct exercises, directed to balance, strengthening and flexibility. The end user 102 may complete a profile that creates an initial baseline program based on the goals and capabilities of the end user 102. As will be described in more detail below, if the end user 102 find a module to be too easy or too difficult, the end user 102 may activate a control to make the exercise associated with the module harder or easier. For example, the end user 102 may switch from Exercise A2 to Exercise B3 if the end user 102 finds Exercise B2 too easy. Similarly, the end user 102 may switch from Exercise B3 to Exercise C2 if the end user 102 finds Exercise C3 too hard. Thus, the end user 102 is in control of the level of difficult at all times throughout the program 108, such that the end user 102 is challenged at a comfortable level of difficulty.

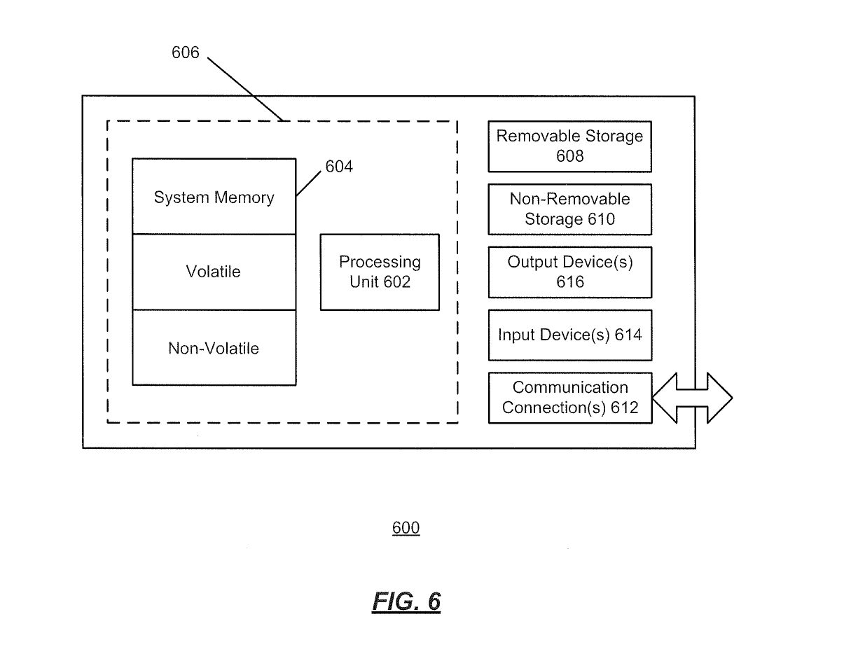

Referring again to FIG. 1, in accordance with the level of difficulty, a video may be retrieved from a server 110 and delivered over, e.g., the Internet or any other suitable network infrastructure to the video player/control panel 106 for display to the end user 102. The server 110 may contain video that is indexed for quick retrieval. The server may be a cloud service that enables a provider to organize each exercise into “buckets” (the modules). Each bucket contains multiple file types (.webm, .ogv. mp4) of the same exercise video. The end user's browser reaches into the bucket and pulls whichever file type it prefers, allowing the site to achieve cross-platform and cross-browser compatibility. The server 110 and the end-user computing devices described above may be implemented as an example computing device, as described below with reference to FIG. 6.

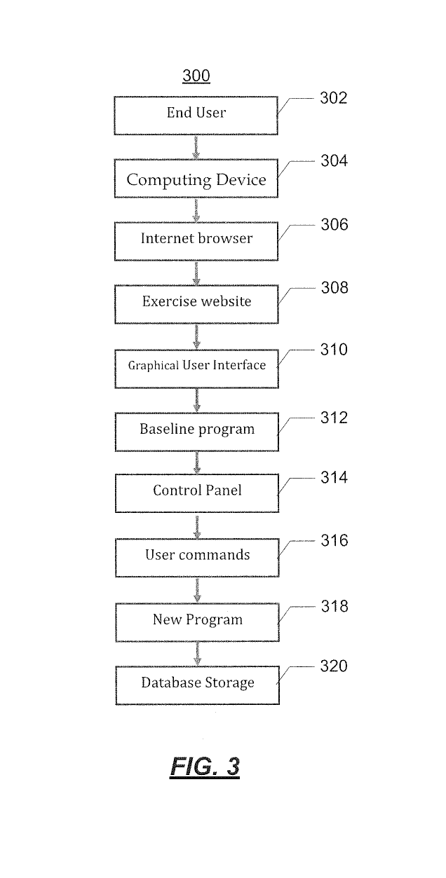

FIG. 3 illustrates an operational flow 300 of an example process in accordance with the present disclosure. At 302-306, the end user engages a computing device and opens, e.g., an Internet browser. At 308, utilizing the Internet browser, the end user 102 accesses the website associated with the exercise application provider. At 310, the website presents a graphical user interface to the end user 102, through which the end user inputs commands.

At 312, the end user 102 establishes their baseline program through a “level setting” process. The end user 102 is taken through a series of modules (e.g. Balance 1, Balance 2, Strength 1, etc). Each module contains several exercises, each with a different level of difficulty. To establish the program, the end user may being each module with the easiest exercise.

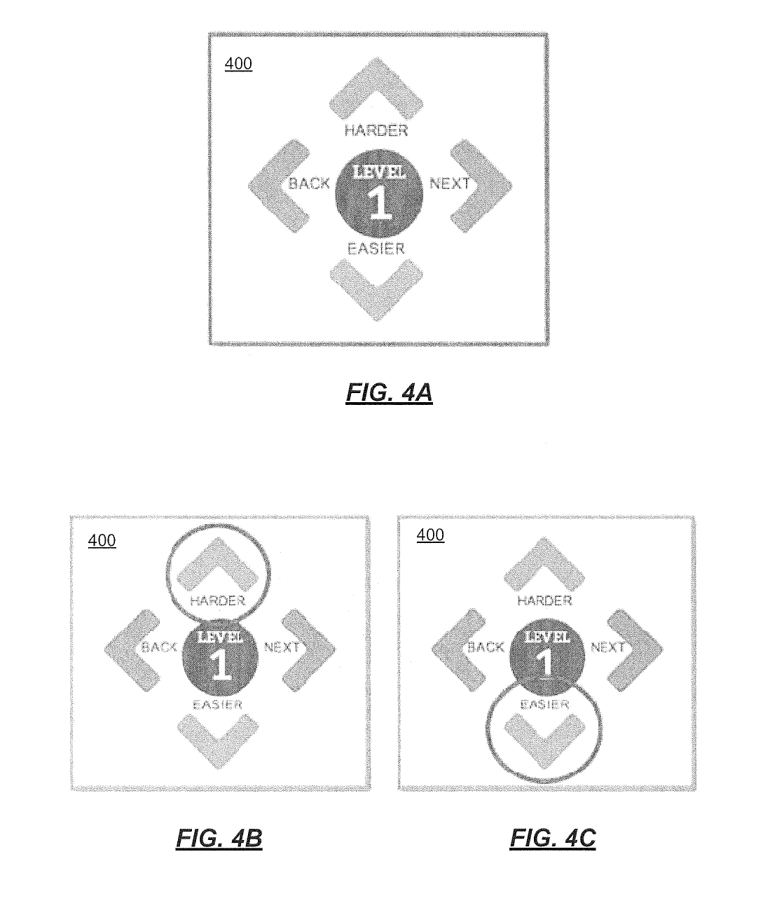

In accordance with the above, the end user 102 may be directed to either increase the level of difficulty with the module, or continue to the next module based on physical feedback cues provided by the content. To increase the level of difficulty, at 314, a control panel 400 is presented, such as that illustrated in FIGS. 4A-4C. As shown, the end user 102 may increase the level of difficultly by activating the “HARDER” (FIG. 4B) or decrease the level of difficulty by activating the “EASIER” button (FIG. 4C). Thus, the control panel 400 is the user interface element that enables the end user 102 to change core elements of the retrieved exercise videos, such as difficulty level. The baseline program is set once the end user has completed this process for all modules.

Next, at a point in time when the end user 102 returns to access their program and wishes to alter the exercise difficulty level within a module, the end user 102 may input a command at 316 through the control panel 400, which retrieves the exercise of the next hardest difficulty level within that module. Each command results in a change of difficulty level only for the module in which the command was executed. The changes in difficulty levels within all modules result in a new, re-baselined program at 318 that may be stored in a database at 320 for future retrieval. In some implementations, the baseline and re-baselined programs are stored in a database on a per-user basis and retrieved by the application based upon user authentication performed on the website.

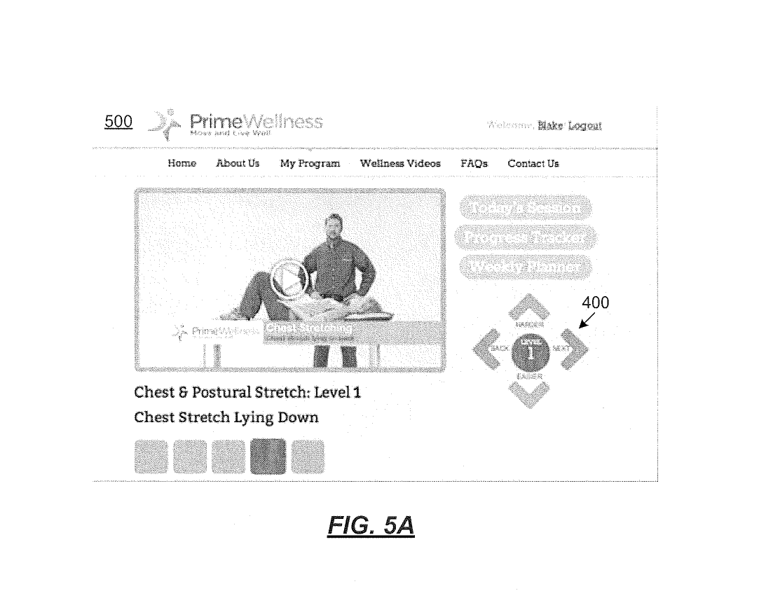

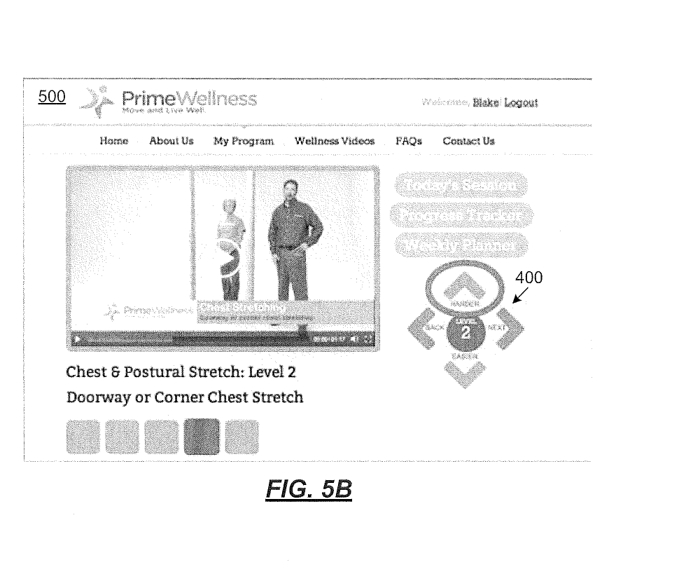

FIGS. 5A and 5B illustrate example user interfaces. FIG. 5A illustrates a “My Program” page 500, which is the principal web page delivering online exercise program content to the end user 102. The control panel 400 may be provided in the bottom left quadrant of the page 500 to enable the end user 102 to alternate between “Harder” and “Easier” difficulty levels. The difficulty level (with “1” being the easiest) is shown in the center circle within the control panel 402. FIG. 5B illustrates the “My Program” page 500 in which the end user 102 has activated the “Harder” button, prompting the program 108 to retrieve a more difficult exercise from the server 110. Subsequently, the level depicted in the center of the control panel 400 has changed to “2”.

Thus, as described above, there is disclosed a mechanism that enables an end user to, on-the-fly, select a level of difficulty of a module within of an exercise program 108 to uniquely tailor the level of difficultly of the entire exercise program 108 to the end user's abilities and comfort level.

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for customizing an exercise program having a plurality of modules, each of the plurality of modules having a plurality of levels of difficulty, comprising:
communicating a web page from a website associated with exercise application to an end user at a computing device;
presenting the exercise program in a graphical user interface that includes a control panel having level of difficulty controls that change a level of difficulty of one of the plurality of modules currently being displayed in the graphical user interface;
receiving, via the control panel in the graphical user interface, end user commands;
altering a level of difficultly of the one of the plurality of modules currently being displayed in the graphical user interface by retrieving another of the plurality of levels of difficulty of the one of the plurality of modules currently being displayed; and
storing, on a per-end user basis, the altered level of difficulty of the one of the plurality of modules currently being displayed in a database.

2. The method of claim 1, further comprising establishing a baseline exercise program through a level setting process by taking the end user through a series of the plurality of modules.

3. The method of claim 2, further comprising beginning each of the plurality of modules at an easiest level of the plurality of levels of difficulty.

4. The method of claim 2, further comprising directing the end user to increase the level of difficulty with a particular one of the plurality of modules using the control panel.

5. The method of claim 2, further comprising storing changes in levels of difficulty within the plurality of modules in a new, re-baselined exercise program.

6. The method of claim 1, wherein the control panel includes controls to increase the level of difficultly or decrease the level of difficulty on-the-fly as the exercise program is presented in the graphical user interface.

7. The method of claim 1, wherein an input received from the control panel only results in a change of difficulty of the one of the plurality of modules currently being displayed.

8. The method of claim 1, further comprising presenting the graphical user interface having a video player, the control panel, and a storyboard depicting each exercise in the exercise program is in a row of tiles below the video player.

9. The method of claim 1, further comprising starting a video presentation associated with the altering a level of difficultly of the one of the plurality of modules from the beginning after receiving the end user commands.

10. The method of claim 1, further comprising indexing the plurality of levels of difficulty at a server for retrieval in accordance with the end user commands.

11. A tangible computer readable medium containing computer-executable instructions, that when executed by a processor cause a computing device to execute a method for customizing an exercise program having a plurality of modules, each of the plurality of modules having a plurality of levels of difficulty, comprising:
communicating a web page from a website associated with exercise application to an end user at a computing device;
presenting the exercise program in a graphical user interface that includes a control panel having level of difficulty controls that change a level of difficulty of one of the plurality of modules currently being displayed in the graphical user interface;
receiving, via the control panel in the graphical user interface, end user commands;
altering a level of difficultly of the one of the plurality of modules currently being displayed in the graphical user interface by retrieving another of the plurality of levels of difficulty of the one of the plurality of modules currently being displayed; and
storing, on a per-end user basis, the altered level of difficulty of the one of the plurality of modules currently being displayed in a database.

12. The tangible computer readable medium of claim 11, further comprising establishing a baseline exercise program through a level setting process by taking the end user through a series of the plurality of modules.

13. The tangible computer readable medium of claim 12, further comprising beginning each of the plurality of modules at an easiest level of the plurality of levels of difficulty.

14. The tangible computer readable medium of claim 12, further comprising directing the end user to increase the level of difficulty with a particular one of the plurality of modules using the control panel.

15. The tangible computer readable medium of claim 12, further comprising instructions for storing changes in levels of difficulty within the plurality of modules in a new, re-baselined exercise program.

16. The tangible computer readable medium of claim 11, wherein the control panel includes controls to increase the level of difficultly or decrease the level of difficulty on-the-fly as the exercise program is presented in the graphical user interface.

17. The tangible computer readable medium of claim 11, wherein an input received from the control panel only results in a change of difficulty of the one of the plurality of modules currently being displayed.

18. The tangible computer readable medium of claim 11, further comprising instructions for presenting the graphical user interface having a video player, the control panel, and a storyboard depicting each exercise in the exercise program is in a row of tiles below the video player.

19. The tangible computer readable medium of claim 11, further comprising instructions for starting a video presentation associated with the altering a level of difficultly of the one of the plurality of modules from the beginning after receiving the end user commands.

20. The tangible computer readable medium of claim 11, further comprising instructions for indexing the plurality of levels of difficulty at a server for retrieval in accordance with the end user commands.
